(19) United States
(12) Patent Application Publication
(10) Pub. No.: US 2009/0011913 A1
(43) Pub. Date: Jan. 8, 2009

(54) Tire for material treatment system

(75) Inventors: Qingsheng Lin, Holden, MA (US); Angelos Kokkinos, Ayer, MA (US); Joshua Creelman, Worcester, MA (US); Gregory L. Morse, Auburn, MA (US); Ivo Slezak, Hubbardston, MA (US)

Correspondence Address: EDWARDS ANGELL PALMER & DODGE LLP, P.O. BOX 55874, BOSTON, MA, 02205, US

(73) Assignee: Babcock Power Inc., Worcester, MA (US)

(21) Appl. No.: 11/824,616

(22) Filed: Jul. 2, 2007

(51) Int. Cl. F16C 13/00; B23C 3/00; B23Q 3/18; B60B 9/00

(52) U.S. Cl. 492/58; 409/64; 483/1; 492/21

(57) ABSTRACT

The invention provides a tire and a roll wheel assembly used to crush material in a pulverizer including a generally toroidal body having a crushing surface on the outer periphery thereof. The crushing surface is configured and adapted to contact and crush the material within the pulverizer. At least one beveled surface is defined on an inner periphery of the body. The beveled surface is configured and adapted to engage a wedge disposed on a roller wheel of a roll wheel assembly to hold the tire on the roller wheel. The invention also provides a method of securing a tire to a roller assembly in a pulverizer for crushing material.

### BACKGROUND OF THE INVENTION

1. Field of the Invention

The present invention relates to in general to grinding elements for pulverizers. Particularly, the present invention is directed to a tire for use in a roll wheel assembly for a pulverizer that reduces complications in the manufacture and assembly of roll wheel assemblies.

2. Description of Related Art

Pulverizers are commonly used to grind various materials in the coal processing, ceramic, and chemical industries. A roll and race pulverizer uses grinding elements comprising a plurality of roll wheel assemblies or tires suspended from driving arms and which rotate around their respective axes of rotation through contact against a grinding ring or race for grinding and reducing the size of the incoming material, particularly coal. Each grinding element or roll wheel assembly uses a replaceable outer tire. Currently, the replaceable outer tires used in the roll wheel assemblies are manufactured from alloy as a casting.

For vertical roller-table mills, for example, the roller wheel is one of the main wear components that need to be protected for long service life. Typically, the roller wheel is protected with a tire made with wear resistant materials. The tire is designed to have an interference fit with the wheel to prevent slippage between the tire and wheel. During the wheel and tire assembling process, the tire needs to be thermally expanded by heating in order for the tire to fit over the wheel. The requirement for this interference fit may result in the tire cracking due to excessively tight fit or an improper heating process being employed. On the other hand, there could be a slippage between the tire and wheel if the interference fit is too loose, which will damage the wheel. The tight tolerance requirement for the interference fit between tire and wheel requires high precision machining for the tire bore inner circumference and the wheel outer circumference in order to properly fit the tire over the wheel.

The tires wear out during normal pulverizer operation. If the wear is uneven, replacement of the tire can be postponed by rotation; i.e., a side-to-side reversal of the partly worn tire comprising each roll wheel assembly. Whether rotating tires or replacing them altogether, the removal and installation of the tires under the state of the art is costly and time consuming. To perform this operation the pulverizer has to be stopped and taken out of service for a significant period of time. The task of pulverizer tire rotation/replacement requires removal of the entire roll wheel assembly from the pulverizer through an access door. Under the state of the art, this is a difficult and labor-intensive operation; special equipment is required because each roll assembly can weigh as much as 35,000 pounds. Once removed from the pulverizer, the tires must be disassembled from the roll wheel assemblies by performing a heating operation, as described above, with the related risks of local overheating and resultant cracking.

Thus a need exists for an improved pulverizer tire for a roll wheel assembly that can provide for quicker, easier pulverizer tire installation, rotation, and replacement. There is also a need for a pulverizer tire with lower manufacturing tolerance requirements and interference fit between tires and roller wheel.

### SUMMARY OF THE INVENTION

The purpose and advantages of the present invention will be set forth in and become apparent from the description that follows. Additional advantages of the invention will be realized and attained by the methods and systems particularly pointed out in the written description and claims hereof, as well as from the appended drawings.

To achieve these and other advantages and in accordance with the purpose of the invention, as embodied herein, the invention includes a tire for a roll wheel assembly used to crush material in a pulverizer. The tire includes a generally toroidal body having a crushing surface on an outer periphery of the body. The crushing surface is configured and adapted to contact and crush the material within the pulverizer. The body also includes at least one beveled surface defined on an inner periphery of the body. The at least one beveled surface is configured and adapted to engage a wedge disposed on a roller wheel of the roll wheel assembly to hold the tire on the roller wheel.

In accordance with a further aspect of the invention, first and second beveled surfaces may be provided on the inner periphery of the body that are configured and adapted to cooperate with a plurality of wedges disposed on the roller wheel to hold the tire on the roller wheel. The body can have a cross-section symmetrical about a centerline perpendicular to an axis of revolution of the body. It is also possible for the body to have a cross-section that is asymmetrical about a centerline perpendicular to an axis of revolution of the body. The tire can include a material selected from the list including cast iron, cast white iron, weld overlay abrasion resistant materials, and any other suitable wear resistant materials.

The invention also provides a roll wheel assembly for crushing material in a pulverizer. The roll wheel assembly includes a roller wheel engaged with a tire by way of at least one wedge. The tire includes a generally toroidal body having a crushing surface on an outer periphery thereof. The crushing surface is configured and adapted to contact and crush the material within the pulverizer. A beveled surface may be defined on an inner periphery of the body. The tire may be engaged with the roller wheel by the wedge proximate the beveled surface. It is possible for the tire to have a single beveled surface. It is also possible for the tire to have two beveled surfaces.

In accordance with another aspect of the invention, a first beveled surface of the tire may be engaged with a first frustoconical surface on the wedge. The roller wheel may have a second frustoconical surface defined proximate its outer periphery. The second frustoconical surface may be engaged with a second beveled surface of the tire. At least one adjustable fastener can join the wedge to the roller wheel, wherein the at least one adjustable fastener may urge the first and second frustoconical surfaces toward each other. A wear protection plate can be disposed on an exposed portion of the at least one wedge. The wear protection plate can be configured and adapted to substantially isolate the respective wedge from material being crushed in the pulverizer.

In accordance with a further aspect of the invention, a first beveled surface of the tire may be engaged with a first wedge. A second beveled surface of the tire may be engaged with a second wedge. At least one fastener may be used to join the first wedge to the second wedge. The at least one adjustable fastener can be used to urge the first and second wedges toward each other when the fastener is tightened.

The invention further provides a vertical roller table mill for crushing material. The vertical roller table mill includes a pulverizer housing, a grinding ring disposed within the pulverizer housing, a plurality of roll wheel assemblies disposed within the pulverizer housing, and a loading assembly operatively connected to the plurality of roller wheel assemblies. Each roll wheel assembly includes a roller wheel, at least one wedge engaged to the roller wheel, and a tire. The tire includes a generally toroidal body having a crushing surface on an outer periphery thereof configured and adapted to contact and crush the material within the roller-table mill, and at least one beveled wedge-receiving surface defined on an inner periphery of the body. The at least one beveled surface is engaged with a wedging surface of the at least one wedge to lock the tire to the wheel. The loading assembly is configured and adapted to urge the plurality of wheel assemblies toward the grinding ring to crush the material between the grinding ring and the crushing surface of the tires as the tires roll along the grinding ring. The loading assembly can include a spring loading assembly, hydropneumatic loading assembly, or any other suitable loading system for urging the plurality of wheel assemblies toward the grinding ring to crush the material between the grinding ring and the crushing surface of the tires as the tires roll along the grinding ring.

In accordance with another aspect of the invention, a first beveled surface of the tire may be engaged with a first frustoconical surface on a wedge. The roller wheel may have a second frustoconical surface defined proximate its outer periphery. The second frustoconical surface may be engaged with a second beveled surface of the tire. At least one adjustable fastener can join the wedge to the roller wheel, wherein the at least one adjustable fastener can be adjusted to tighten the engagement of the first and second frustoconical surfaces urging the first and second frustoconical surfaces toward each other. A wear protection plate can be disposed on an exposed portion of the at least one wedge. The wear protection plate can be configured and adapted to substantially isolate the respective wedge from material being crushed in the pulverizer.

In accordance with a further aspect of the invention, a first beveled surface of the tire may be engaged with a first frustoconical surface on a first wedge. A second beveled surface of the tire may be engaged with a second frustoconical surface on a second wedge. At least one adjustable fastener can join the first wedge to the second wedge. The at least one adjustable fastener can urge the first and second wedges toward each other when tightened.

The invention also provides a method for securing a tire to a roller wheel assembly in a pulverizer for crushing material. The method includes providing a roller wheel and providing at least one wedge configured and adapted to be engaged with the roller wheel and a tire by way of at least one wedging surface defined thereon. The method further includes providing a tire including a generally toroidal body having a crushing surface on an outer periphery thereof. The crushing surface is configured and adapted to contact and crush the material within the pulverizer. At least one beveled surface is defined on an inner periphery of the body. The tire is configured and adapted to engage the roller wheel by the wedge proximate the at least one beveled surface. The method also includes affixing the at least one wedge and the tire to the roller wheel wherein the at least one wedging surface of the at least one wedge engages a beveled surface of the tire.

In accordance with a further aspect of the invention, the method further includes providing a fastener. The fastener may be tightened to urge the wedge into the beveled surface of the tire until the tire is secured to the roller wheel assembly. The method can further include affixing at least one wear protection plate to an exposed surface of the at least one wedge.

It is to be understood that both the foregoing general description and the following detailed description are exemplary and are intended to provide further explanation of the invention claimed. The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 is a partially cut-away perspective view of a pulverizer, showing a typical location of a roll wheel assembly for crushing material.

FIG. 2 is a cross-sectional perspective view of a roll wheel assembly of the pulverizer of FIG. 1, showing the roller wheel and the tire.

FIG. 3 is cross-sectional view of the roll wheel assembly of FIG. 2, showing the interference fit between a traditional pulverizer tire and the roller wheel.

FIG. 4 is a cross-sectional view of a first representative embodiment of a tire for a pulverizer in accordance with the present invention, showing wedges engaged between the roller wheel and beveled surfaces on the inner periphery of the tire.

FIG. 5a is a cross-sectional side view of the wedge of FIG. 4 in accordance with the present invention, showing the slots in the innermost surface of the ring wedge, and also showing the attachment bores passing through the wedge.

FIG. 5b is a back view of the wedge of FIG. 5a in accordance with the present invention, showing the frustoconical surface and the pattern of slots and attachment bores passing through the wedge.

FIG. 5c is a cross-sectional side view of the wedge of FIG. 5a in accordance with the present invention, showing the slots in the innermost surface of the ring wedge, and also showing the small bores in the outer surface of the wedge for attachment of a wear protection plate.

FIG. 5d is a front view of the wedge of FIG. 4 in accordance with the present invention, showing the small bores in the outer surface of the wedge for attachment of a wear protection plate.

FIG. 6a is a back view of another embodiment of a wedge for use with a tire in accordance with the present invention, showing twelve individual wedge segments that can be used to attach a tire to a wheel assembly.

FIG. 6b is a cross-sectional elevation view of the wedge of FIG. 6a in accordance with the invention, showing the inner surface of the wedge made of a plurality of individual wedge segments.

FIG. 6c is a front view of the wedge of FIG. 6a in accordance with the invention, showing the attachment bores passing through the individual wedge segments.

FIG. 7 is a cross-sectional view of a second representative embodiment of a tire for a pulverizer in accordance with the present invention, showing the roller wheel having an integrated wedge engaged to a first beveled surface of the tire, and a wedge engaged between the roller wheel and a second beveled surface of the tire.

### DETAILED DESCRIPTION OF THE PREFERRED EMBODIMENT

Reference will now be made in detail to the present preferred embodiments of the invention, examples of which are illustrated in the accompanying drawings. The method and corresponding steps of the invention will be described in conjunction with the detailed description of the system.

The devices and methods presented herein may be used for installing, rotating, and replacing tires in a roll wheel assembly in a pulverizer. The present invention is also well suited for lowering required tolerances for manufacturing roller wheels and tires for pulverizers.

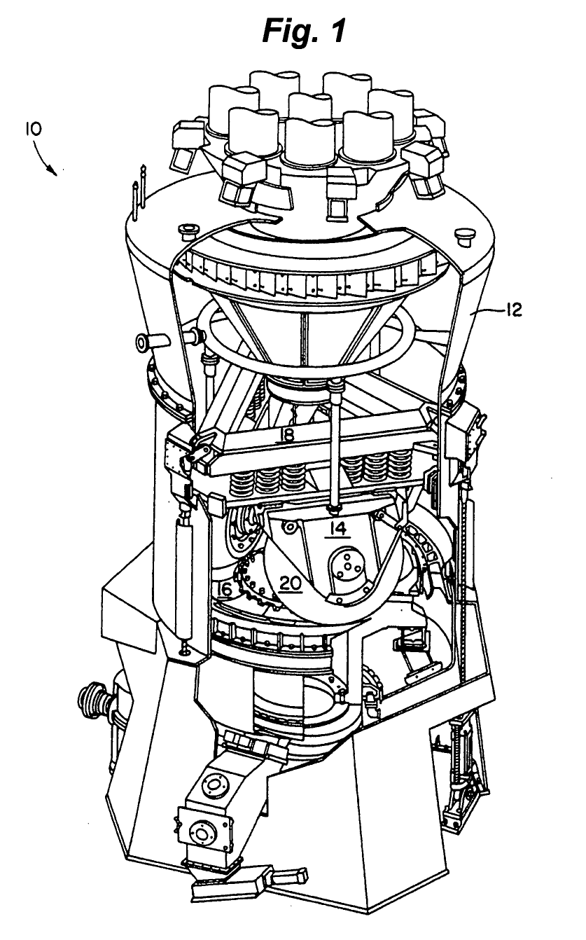

Referring to the Figures generally, wherein like numerals designate the same element throughout the several drawings, FIG. 1 shows a perspective view of a vertical roller-table mill generally designated 10, for grinding incoming material such as coal. The grinding or crushing of coal in the pulverizer 10 is conducted within a pulverizer housing 12. The pulverizer housing 12 contains a plurality of roll wheel assemblies 14, typically three in number, which are pressed against a grinding ring 16 by a spring loading system 18. The grinding ring 16 rotates about a vertical axis of the pulverizer 10, and each of the plurality of roll wheel assemblies 14 has a replaceable outer grinding element or tire 20 mounted for rotation thereon. Each tire 20 rotates around its respective axis of rotation through contact against the grinding ring 16. Incoming material is crushed between tires 20 and grinding ring 16.

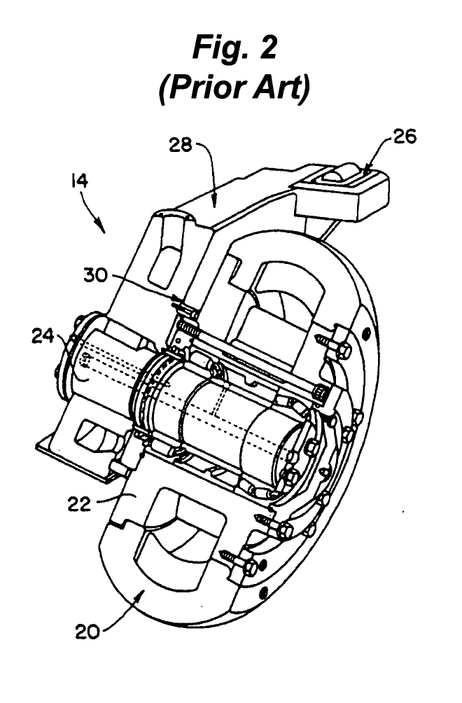

Referring to FIG. 2, each roll wheel assembly 14 comprises a replaceable outer grinding element or tire 20 supported on a tire support 22 rotatably mounted about an axle 24 of the roll wheel assembly 14. Each roll wheel assembly 14 uses a roll pin block 26 and a roller bracket 28 to allow the tire 20 to rotate about its axis as the grinding ring 16 rotates within the pulverizer 10. A roll air seal 30 is provided for sealing coal and other abrasive particles out of the roll wheel assembly 14.

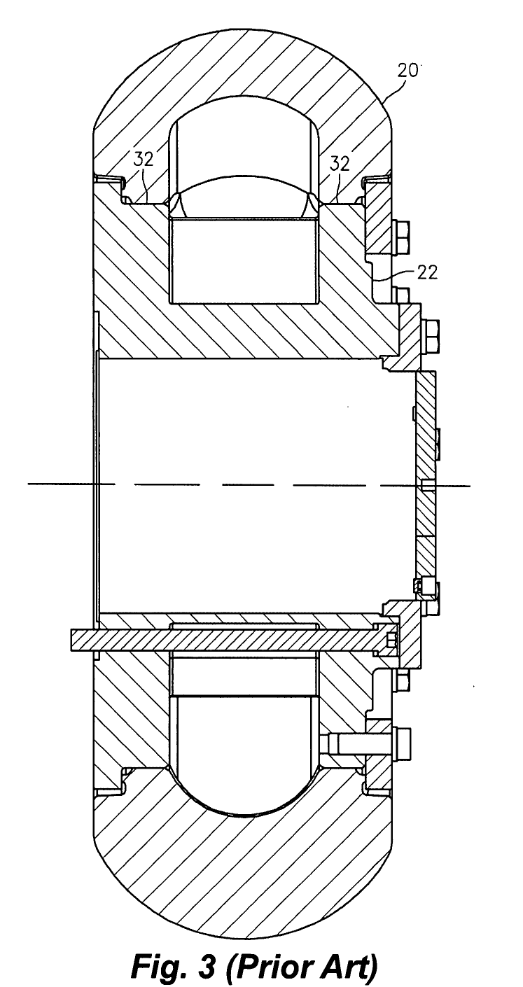

FIG. 3 shows the traditional interference fit 32 between tire 20 and tire support 22. The diameter of the inner circumference of tire 20 is slightly smaller than the diameter of the corresponding surface on tire support 22. Thus the inner circumference of tire 20 must be expanded in order for tire 20 to fit over tire support 22 during installation. Traditionally, the expansion of tire 20 has been accomplished with various heating techniques. When thermally expanded, tire 20 can be installed on tire support 22. As tire 20 cools, it contracts and tightens around tire support 22 to create interference fit 32. The heating process runs a risk of cracking tire 20 due to possible uneven thermal expansion. Moreover, if the interfering surfaces of tire 20 and tire support 22 are not manufactured with sufficient tolerances, the fit will be either too tight, or too loose, leading to further risk of cracking tire 20 or damaging tire support 22.

In accordance with the invention, a tire for a roll wheel assembly used to crush material in a pulverizer is provided including a generally toroidal body having a crushing surface on an outer periphery thereof. The crushing surface is configured and adapted to contact and crush the material within the pulverizer. There is at least one beveled surface defined on an inner periphery of the body. The at least one beveled surface is configured and adapted to engage a wedge disposed on a roller wheel of the roll wheel assembly to hold the tire on the roller wheel.

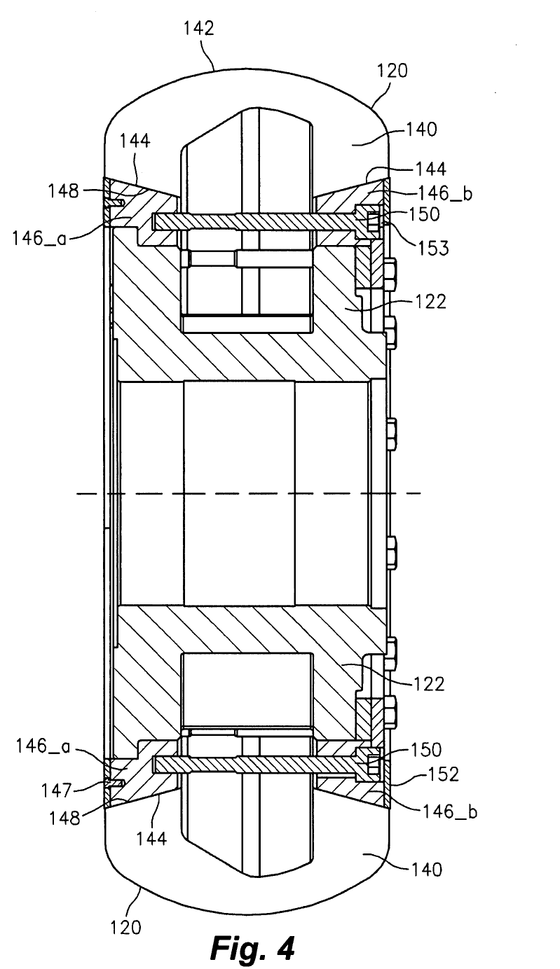

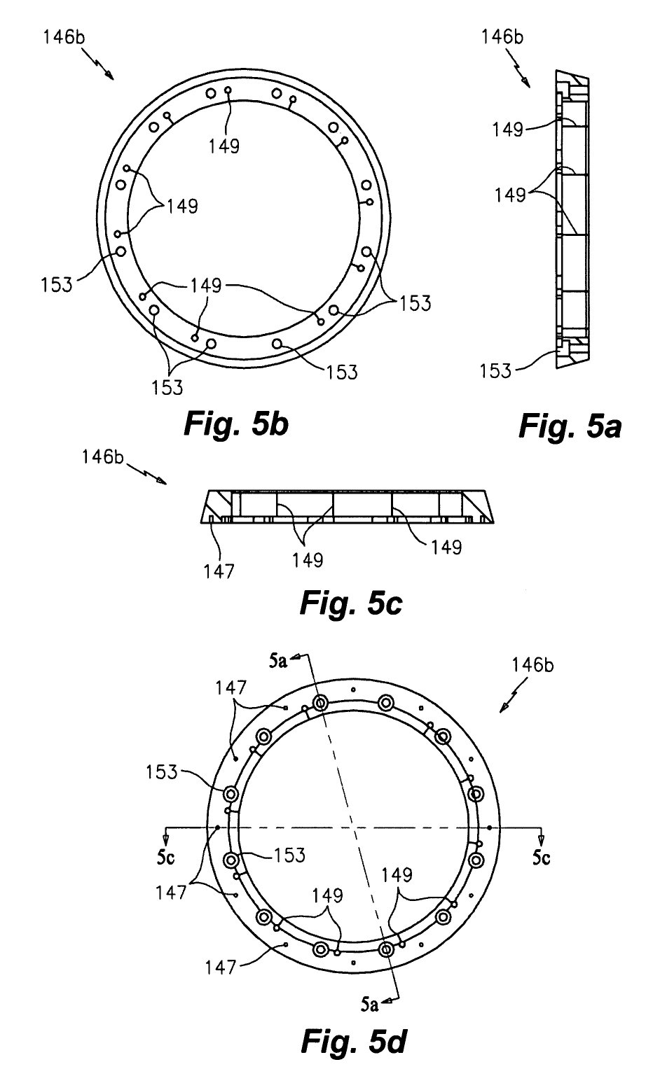

For purpose of explanation and illustration, and not limitation, a partial view of an exemplary embodiment of the tire for a roll wheel assembly in accordance with the invention is shown in FIG. 4 and is designated generally by reference character 120. Other embodiments of a tire and roll wheel assembly in accordance with the invention, or aspects thereof, are provided in FIGS. 5-7, as will be described.

In accordance with the invention, a generally toroidal body is provided having a crushing surface on its outer periphery and at least one beveled surface on its inner periphery. For purposes of illustration and not limitation, as embodied herein and as depicted in FIG. 4, tire 120 is provided with a generally toroidal body 140. Body 140 is shown having an asymmetrical cross-section with respect to a line perpendicular to the axis of revolution X. This asymmetrical cross-section can be the same as that described in U.S. Pat. No. 5,346,148, which is incorporated by reference herein in its entirety. This asymmetrical cross-section has certain advantages, such as extending the wear life of tire 120 before it must be rotated or replaced. However, it is also possible to practice the invention with the tire having any suitable cross sectional shape, including symmetrical cross-sections, without departing from the spirit and scope of the invention.

Body 140 has a crushing surface 142 on its outer periphery. Crushing surface 142 contacts a corresponding surface (e.g. grinding ring 16) and/or material to be crushed on grinding ring 16. As tire 120 rolls over grinding ring 16, material caught between crushing surface 142 and grinding ring 16 is crushed. Materials used for tire 120 are generally chosen based on ability to withstand wear from constant grinding operations of this type. Typical materials include cast iron, cast white iron, weld overlay wear resistant material, and any other suitable type of wear resistant material, as will be appreciated by those skilled in the art, without departing from the spirit and scope of the invention.

With continued reference to FIG. 4, for purposes of illustration only, as depicted, tire 120 includes a plurality of beveled surfaces 144 proximate its inner periphery. While two beveled surfaces 144 are shown, those skilled in the art will appreciate that any number of beveled surfaces can be used. Beveled surfaces 144 engage frustoconical surfaces 148 of wedges 146a,b disposed on tire support 122 to make roll wheel assembly 114, a portion of which is shown in FIG. 4. A plurality of fasteners 150 connects one wedge 146a to another wedge 146b across tire 120 through bores 153 defined through the wedges 146a,b. Tightening fasteners 150 urges the two wedges 146a,b closer together. As wedges 146a,b are urged closer together, they tend to press against beveled surfaces 144 of tire 120, as well as the outer periphery of tire support 122, thus tightening the engagement of tire 120 to tire support 122. When tire 120 has a sufficient lock on tire support 122, fasteners 150 need be tightened no further, so there is little risk of cracking tire 120. Wear plate 152 is installed over at least a portion of the exposed surface of wedge 146a,b to protect against wear within the pulverizer, however, those skilled in the art will readily appreciate that wear plates 152 are optional.

FIG. 4 shows tire 120 attached to a wheel assembly by two wedges 146a and 146b that are not identical to each other. Wedge 146a includes an inner periphery that is stepped, to engage a corresponding stepped surface on the wheel assembly. Wedges 146a,b include small bores 147 for receiving a wear protection plate 152 (see FIGS. 5a-5d). Wedge 146a can be attached to the wheel assembly using an interference fit, a weld, a clearance fit (where contact is secured through tightening of the fasteners 150), or any other suitable attachment means. Wedge 146b is attached to the wheel assembly using a clearance fit, however, those skilled in the art will readily appreciate that any suitable means of attaching the wedges to the wheel assembly can be used without departing from the spirit and scope of the invention.

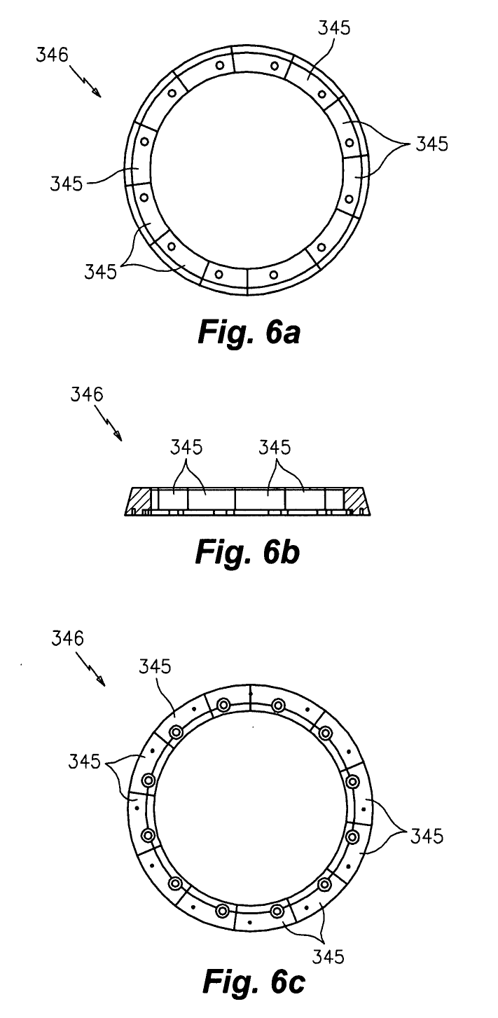

As shown in FIGS. 5a-5d, wedge 146b is a single ring shaped wedge. However, it is possible to use a plurality of individual wedge segments, such as wedge 346 shown in FIGS. 6a-6c, made of twelve individual wedge segments 345. In the case of a single ring shaped wedge, as in FIGS. 5a-5d, wedge 146b has slots 149 cut at equal spacing, allowing wedge 146b to be tightened into place using fasteners 150. Similarly, wedge 146a can be a single ring shaped wedge, or a plurality of multiple wedges.

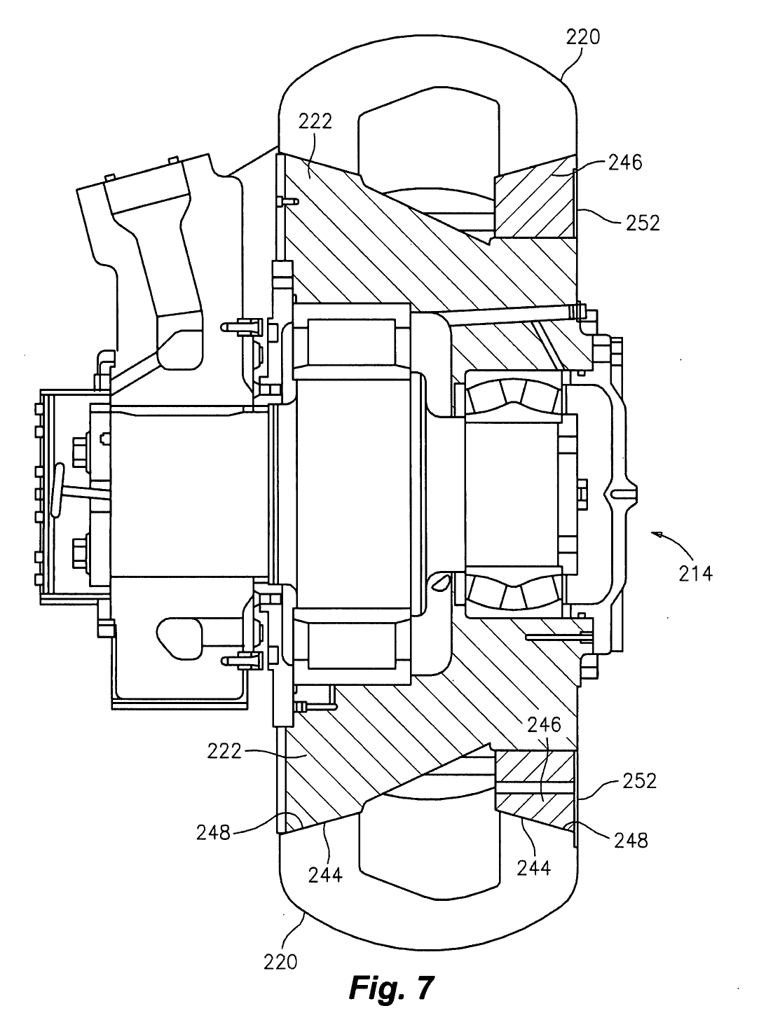

FIG. 7 shows a portion of another roller wheel assembly 214 in accordance with the present invention. Wheel support 222 has a frustoconical surface 248 integrated thereon so that only one wedge 246 is required for installing tire 220. Wedge 246 can be a single ring shaped wedge or a plurality of individual wedge segments, as described above. Frustoconical surface 248 engages a first beveled surface 244 of tire 220 and a frustoconical surface 248 of wedge 246 engages an opposing beveled surface 244. A fastener (not shown, but see 150 in FIG. 4) fixes wedge 246 directly to tire support 222. Tightening the fastener urges wedge 246 toward frustoconical surface 248 of tire support 222, locking tire 220 to tire support 222 as described above with reference to tire 122. Wear plate 252 is installed over the exposed surface of wedge 246 to protect against wear within the pulverizer, however, those skilled in the art will readily appreciate that wear plates 252 are optional.

Those skilled in the art will readily appreciate that the invention can also be practiced with a single beveled surface on the tire engaging a frustoconical surface of a wedge on one side of the tire. The other side of the tire can be supported in the same manner as shown in FIG. 3 albeit with a looser fit rather than the traditional interfering fit. Therefore those skilled in the art will readily appreciate that the invention can function with one or two beveled surfaces without departing from the spirit and scope of the invention.

The tires 120, 220 and roll wheel assemblies 114, 214 shown in FIGS. 4-7 eliminate the need for the traditional interference fit between tire and roller wheel. One distinct advantage of eliminating the interference fit is that it is no longer necessary to thermally expand the inner portion of the tire in order to fit it over a tire support during installation. This reduces the risk of cracking the tire during heating and cooling. Moreover, the down time required for changing tires is reduced because the heating step is eliminated. Another distinct advantage is that it is no longer necessary to manufacture tires and tire supports to the demanding tolerances required by the traditional interference fit. Since there is no need for the interference fit, the tire and tire support can be manufactured with looser tolerances, thus lowering the cost of manufacture.

In accordance with another aspect of the invention, a method for securing a tire to a roller wheel assembly in a pulverizer for crushing material is provided. The method includes the steps of providing a roller wheel, and engaging at least one wedge to be with the roller wheel and a tire by way of at least one wedging surface defined on the wedge. The tire includes a generally toroidal body having a crushing surface on an outer periphery thereof. The crushing surface is configured and adapted to contact and crush the material within the pulverizer. At least one beveled surface is defined on an inner periphery of the body. The tire is configured and adapted to engage the roller wheel by the wedge proximate the at least one beveled surface. The method further includes affixing the at least one wedge and the tire to the roller wheel wherein the at least one wedging surface of the at least one wedge engages a beveled surface of the tire.

For purposes of illustration and not limitation, as embodied herein and as depicted in FIGS. 1-6, the method provides steps for securing a tire to a roller wheel assembly in a pulverizer, e.g. vertical roller-table mill 10, for crushing material. The method includes providing a roller wheel, such as in roller wheel assemblies (e.g. 114, 214) described above. At least one wedge is provided (e.g. 146a,b and 246). The wedge is configured and adapted to be engaged to the roller wheel (e.g. 122, 222) and has a first wedge surface on its outer periphery. It is possible, for example, to practice the method with two wedges (e.g. 146a,b described above with respect to FIG. 4). It is also possible to practice the method with a single wedge (e.g. 246) in the case of the roller wheel having a tire support (e.g. 222) with an integrated wedge surface as described above with respect to FIG. 7, without departing from the spirit and scope of the invention.

The method includes providing a tire (e.g. 120, 220), as described above in conjunction with FIGS. 4-6. The tire includes at least one beveled surface (e.g. 144, 244), as described above. The method further includes affixing the at least one wedge and the tire to the roller wheel wherein the wedging surface of the at least one wedge engages a beveled surface of the tire. If the tire support has one wedge already integrated, as in FIG. 7, then only one wedge needs to be affixed to the roller wheel along with the tire. If the tire support does not have an integrated wedge, two wedges can be affixed in conjunction with the tire, as in FIG. 4.

In further accordance with the invention, the method includes the further step of providing an adjustable fastener (e.g. 150) configured and adapted to join the at least one wedge to another wedge (as in FIG. 4). It is also possible that the fastener be configured to join a single wedge directly to the roller wheel (as in FIG. 7). The method can also include tightening the fastener to secure the tire to the wheel, as described above. It is also contemplated that the method can include affixing at least one wear protection plate to an exposed surface of the at least one wedge, as described above.

While the invention has been described above in the context of a vertical roller-table mill pulverizer, the invention is not limited to a specific type of material pulverizer. Those skilled in the art will readily appreciate that the systems and methods of invention can also be practiced on a variety of other pulverizer devices without departing from the spirit and scope of the invention.

The methods and systems of the present invention, as described above and shown in the drawings, provide for a tire and roll wheel assembly with superior properties including quick, easy installation and removal, as well as relaxed manufacturing tolerance requirements. It will be apparent to those skilled in the art that various modifications and variations can be made in the device and method of the present invention without departing from the spirit or scope of the invention. Thus, it is intended that the present invention include modifications and variations that are within the scope of the appended claims and their equivalents.

What is claimed is:

1. A tire for a roll wheel assembly used to crush material in a pulverizer, the tire comprising a generally toroidal body having:
a) a crushing surface on an outer periphery of the body, the crushing surface being configured and adapted to contact and crush the material within the pulverizer; and
b) at least one beveled surface defined on an inner periphery of the body, the at least one beveled surface being configured and adapted to engage a wedge disposed on a roller wheel of the roll wheel assembly to hold the tire on the roller wheel.

2. A tire as recited in claim 1, wherein first and second beveled surfaces on the inner periphery of the body are configured and adapted to cooperate with a plurality of wedges disposed on the roller wheel to hold the tire on the roller wheel.

3. A tire as recited in claim 2, wherein the body has a cross-section symmetrical about a centerline perpendicular to an axis of revolution of the body.

4. A tire as recited in claim 1, wherein the body has a cross-section that is asymmetrical about a centerline perpendicular to an axis of revolution of the body.

5. A tire as recited in claim 1, wherein the tire includes a material selected from the list consisting of cast iron, cast white iron, and abrasion resistant weld overlay materials.

6. A roll wheel assembly for crushing material in a pulverizer, the roll wheel assembly comprising:
a) a roller wheel;
b) at least one wedge defining at least one wedging surface defined thereon; and
c) a tire including a generally toroidal body having a crushing surface on an outer periphery thereof configured and adapted to contact and crush the material within the pulverizer, and at least one beveled surface defined on an inner periphery of the body, the tire being engaged with the roller wheel by the wedge proximate the at least one beveled surface.

7. A roll wheel assembly as recited in claim 6, wherein a first beveled surface of the tire is engaged with a first frustoconical surface on the wedge, and wherein the roller wheel has a second frustoconical surface defined on its outer circumferential periphery, the second frustoconical surface being engaged with a second beveled surface of the tire.

8. A roll wheel assembly as recited in claim 7, further comprising at least one adjustable fastener joining the wedge to the roller wheel, wherein the first and second frustoconical surfaces may be urged toward each other by tightening the fastener.

9. A roll wheel assembly as recited in claim 6, wherein a first beveled surface of the tire is engaged with a first wedging surface on a first wedge, and wherein a second beveled surface of the tire is engaged with a second wedging surface on a second wedge.

10. A roll wheel assembly as recited in claim 9, further comprising at least one adjustable fastener joining the first wedge to the second wedge, wherein the at least one adjustable fastener is configured and adapted to urge the first and second wedges toward each other when tightened.

11. A roll wheel assembly as recited in claim 6, further comprising a wear protection plate disposed on an exposed portion of the at least one wedge, the wear protection plate being configured and adapted to substantially isolate the respective wedge from material being crushed in the pulverizer.

12. A vertical roller table mill for crushing material, the vertical roller table mill comprising:
a) a pulverizer housing;
b) a grinding ring disposed within the pulverizer housing;
c) a plurality of roll wheel assemblies disposed within the pulverizer housing, each roll wheel assembly including:
i) a roller wheel,
ii) at least one wedge engaged to the roller wheel and having a wedging surface on an outer periphery thereof, and
iii) a tire including a generally toroidal body having a crushing surface on an outer periphery thereof configured and adapted to contact and crush the material within the roller-table mill, and at least one beveled surface defined on an inner periphery of the body, the at least one beveled surface being engaged with the wedging surface of the at least one wedge to lock the tire to the wheel; and
d) a loading assembly operatively connected to the plurality of roller wheel assemblies, the spring loading assembly being configured and adapted to urge the plurality of wheel assemblies toward the grinding ring to crush the material between the grinding ring and the crushing surface of the tires as the tires roll along the grinding ring.

13. A vertical roller table mill as recited in claim 12, wherein a first beveled surface of the tire is engaged with a first frustoconical surface on a wedge, and wherein the roller wheel has a second frustoconical surface defined on its outer circumferential periphery, the second frustoconical surface being engaged with a second beveled surface of the tire.

14. A vertical roller table mill as recited in claim 13, further comprising at least one adjustable fastener joining the wedge to the roller wheel, wherein the at least one adjustable fastener urges the first and second frustoconical surfaces toward each other when tightened.

15. A vertical roller table mill as recited in claim 12, wherein a first beveled surface of the tire is engaged with a first frustoconical surface on a first wedge, and wherein a second beveled surface of the tire is engaged with a second frustoconical surface on a second wedge.

16. A vertical roller table mill as recited in claim 15, further comprising at least one adjustable fastener joining the first wedge to the second wedge, wherein the at least one adjustable fastener is urges the first and second wedges toward each other when tightened.

17. A vertical roller table mill as recited in claim 12, further comprising a wear protection plate disposed on an exposed portion of the at least one wedge, the wear protection plate being configured and adapted to substantially isolate the respective wedge from material being crushed in the pulverizer.

18. A method of securing a tire to a roller wheel assembly in a pulverizer for crushing material, the method comprising:
a) providing a roller wheel;
b) providing at least one wedge defining a wedging surface thereon;
c) providing a tire including a generally toroidal body having a crushing surface on an outer periphery thereof being configured and adapted to contact and crush the material within the pulverizer, and at least one beveled surface defined on an inner periphery of the body, the tire being configured and adapted to engage the roller wheel by the wedge proximate the at least one beveled surface; and
d) affixing the tire to the roller wheel using the wedge.

19. A method as recited in claim 18, wherein the affixing step includes:
a) disposing a fastener through the wedge; and
b) tightening the fastener to urge the wedge against the beveled surface of the tire.

20. A method as recited in claim 19, further comprising:
a) affixing at least one wear protection plate to an exposed surface of the at least one wedge.
